(19) United States
(12) Patent Application Publication
(10) Pub. No.: US 2024/0193682 A1
(43) Pub. Date: Jun. 13, 2024

(54) SYSTEMS AND METHODS FOR CREATING AND EXCHANGING CRYPTOGRAPHICALLY VERIFIABLE UTILITY TOKENS ASSOCIATED WITH AN INDIVIDUAL

(71) Applicant: 453I, Grand Cayman (KY)

(72) Inventor: Jan Rudolf MARKGRAAFF, Mission Viejo, CA (US)

(21) Appl. No.: 18/285,199

(22) PCT Filed: Mar. 31, 2022
(86) PCT No.: PCT/IB2022/052997

§ 371 Date: Sep. 29, 2023

Related U.S. Application Data
(60) Provisional application No. 63/168,803, filed on Mar. 31, 2021.

(51) Int. Cl. G06Q 40/04; G06F 21/64; G06Q 20/36; G06Q 20/40

(52) U.S. Cl. CPC G06Q 40/04; G06F 21/64; G06Q 20/3672; G06Q 20/4014; G06Q 2220/00

(57) ABSTRACT

A computer-implemented method and system is provided for creating and exchanging cryptographically verifiable utility tokens associated with an issuing individual. The utility tokens may be in the form of fungible cryptographic tokens which may be traded once created. A fixed number of utility tokens and non-fungible collectible tokens may be created and, during a first phase, value offers to purchase an unspecified number of utility tokens may be received from a first group of users. At the end of the first phase, a final face value per utility token may be determined. A payment transaction may be facilitated in which each user of the first group of users pays the final face value per utility token and receives a number of utility tokens based on that user's value offer. The purchased utility tokens may each be cryptographically linked to the purchasing user.

### CROSS-REFERENCE TO RELATED APPLICATIONS

This application claims priority from U.S. Provisional Patent Application No. 63/168,803 filed on 31 Mar. 2021, which is incorporated by reference herein.

### FIELD OF THE INVENTION

The invention relates to electronic computer-implemented systems and methods for creating and exchanging cryptographically verifiable utility tokens associated with an individual, and related functionality.

### BACKGROUND TO THE INVENTION

Individuals such as talented persons, athletes, celebrities, musicians, actors, businesspersons, politicians and widely recognized groups and teams, whether amateurs or professionals or the like may wish to achieve their dreams with the support of their families, friends, and supporters. These individuals may wish to empower their supporters and fans to fund their dreams by giving them a “stake” in their future success. Existing social media platforms such as Facebook™ or Twitter™ currently do not provide an effective means for these individuals to empower their supporters. Further, whenever payment is involved, security is a concern and these social media platforms do not provide an effective means for verifying the identity of users.

The applicant is aware of the following platforms that attempts to provide a means for these individuals to empower their supporters. Sorare™: A platform to collect and play with officially licensed European football (soccer) crypto assets, which appears to be focused solely on European football whereby supporters collect unique digital playing cards with value that fluctuates based on performance. Supporters participate in “games” to earn rewards. CrytpoStrikers™: A platform focused solely on European football (soccer), in which supporters acquire unique cards or collectibles that are then traded or swapped between participants. Value is derived from scarcity of the cards or collectibles as well as buy, sell or trade differentials within network of participants. MLB Champions™: A platform focused solely on US Major League Baseball (“MLB”), in which supporters acquire MLB Champions figures in the form of digital assets. Supporters enter figures and/or form rosters, which mirror actual MLB games and players' performance, and holders can earn rewards during gameplay. All digital assets use licenses obtained from the MLB Players Association. Player Tokens™: A platform for the collection of digital assets focused solely on the MLB and the US Women's Soccer team, in which purchasers of the digital assets can transfer them on decentralized exchanges that exist for unique digital assets on the Ethereum™ blockchain, such as OpenSea™. Globatalent™: A platform for tokenizing income streams of professional athletes and teams and providing an exchange on which those tokens can be traded.

The applicant considers there to be scope for improvement.

The preceding discussion of the background to the invention is intended only to facilitate an understanding of the present invention. It should be appreciated that the discussion is not an acknowledgment or admission that any of the material referred to was part of the common general knowledge in the art as at the priority date of the application.

### SUMMARY OF THE INVENTION

In accordance with an aspect of the invention there is provided a computer-implemented method for creating and exchanging cryptographically verifiable utility tokens associated with an issuing individual, comprising:
verifying an identity of an issuing individual in respect of whom utility tokens are to be issued and creating a token issuer account in respect of that issuing individual;
subsequent to verification of the issuing individual's identity, causing a fixed number of utility tokens to be created, each utility token being associated with the issuing individual and being cryptographically verifiable;
receiving registration requests from a plurality of users and creating user accounts for each of the plurality of users,
during a first phase:
   receiving, from each of a first group of users, value offers to purchase an unspecified number of utility tokens;
   generating a face value per utility token that optimizes a number of tokens and a total value of the tokens to be sold to the first group of users; and
   enabling users to be added to the first group of users and enabling the first group of users to each increase their value offer such that the generated face value per utility
upon conclusion of the first phase, generating a final face value per utility token and facilitating a payment transaction in which each user of the first group of users pays the final face value per utility token and receives a number of utility tokens based on that user's value offer, each purchased utility token being cryptographically linked to a user; and
subsequent to the first phase:
   determining a dynamic face value of the utility tokens;
   enabling the issuing individual and any user holding utility tokens to offer to sell utility tokens to a purchasing user at the dynamic face value;
   facilitating a payment transaction in which the purchasing user pays the dynamic face value and receives the offered utility tokens which are then cryptographically linked to the purchasing user.

The first phase may be divided into a number of stages, with the face value per utility token being updated at the end of each stage. The first phase may be 7 days, divided into 7 equal stages of 1 day. At the end of each day all value offers may be tallied and a face value which may be the weighted average price may be generated. On the next day, new value offers may only be received if higher than the face value generated at the end of the previous day, to enable a higher face value per utility token to be generated at the end of the current day. The final face value per utility token may be the weighted average price generated at the end of the 7th day. This may enable the issuing individual a window of opportunity to obtain and establish a best face value of the utility token.

The weighted average price may optimize the number of tokens issued and the total value of the tokens sold to the first group of users. For example, in a first scenario, the first group of users may be 100 users making offers of $1 for each utility token. If the weighted average price generated is $1, then each user may be issued with 10 utility tokens, thus making a total value of the utility tokens sold to be $1,000. In a second scenario, one user may make an offer of $1,000 for each utility token. If the weighted average price generated is $1, then the user may be issued with 1,000 utility tokens, thus making a total value of the utility tokens sold to be $1,000. In both scenarios, 1,000 utility tokens will be issued, and the total value of the utility tokens sold is $1,000.

Subsequent to the first phase, the issuing individual and any user holding utility tokens may offer to sell utility tokens in a secondary exchange. The secondary exchange may be a peer-to-peer market where users can freely trade utility tokens at any price of their choosing. In the secondary exchange, the issuing individual may only list utility tokens for sale at the dynamic face value of the utility tokens. The dynamic face value of the utility tokens may initially be the final face value determined at the end of the first phase and may be continuously redetermined based on the higher of the last executed trade price or the lowest asking price in the secondary exchange. For example, if a user buys a utility token at $5, and there is a utility token for sale at $4.50, then the dynamic face value of the utility token will be $5, which is the highest price at which the utility token was bought. However, if there is a utility token for sale at $6, then the dynamic face value of the utility token will be $6, which is the lowest price at which the utility token is for sale regardless of whether that utility token is sold or not.

The fixed number of utility tokens may be several thousand in the form of fungible cryptographic tokens which may be bought, sold, traded, transferred and or stored by a purchaser once created. In one embodiment, the fixed number of utility tokens may be 100,000.

The method may include, subsequent to verification of the issuing individual's identity, causing a dynamic number of collectible tokens to be created, with each collectible token being associated with the issuing individual and being cryptographically verifiable,
enabling the issuing individual to offer to sell collectible tokens to a purchasing user in a secondary exchange, and
facilitating a payment transaction in which the purchasing user pays for the collectible tokens using utility tokens and/or fiat currency and receives the offered collectible tokens which are then cryptographically linked to the purchasing user.

Collectible tokens may be digital cards in the form of non-fungible cryptographic tokens which may be bought, sold, traded, transferred and or stored by a purchasing user once created. The issuing individual may be someone who wishes to empower his/her supporters and fans by giving them a “stake” in their future success, for example, talented persons, athletes, celebrities, musicians, actors, businesspersons, politicians or the like.

The collectible tokens may include embedded data associated with the individual, the embedded data including an image or video of the individual, and a name of the individual. The embedded data may also include statistics about the individual and examples of work performed by the individual. Each collectible token may have a collectible token type, the collectible token type being classified into the following classes: series, premium, elite and 1-of-1 edition. The collectible tokens may be sold in the secondary exchange at any price.

The method may include determining a global performance index (GPX) of the issuing individual. The GPX may be a dynamic value determined by combining metrics obtained from the sale of utility tokens in the secondary exchange and metrics related to the social interaction between users and the issuing individual. The GPX may be calculated based on: statistics from the secondary exchange on which utility tokens are traded (e.g., the current price, trading volume, volume weighted average prices, or number of holders of utility tokens), statistics from the secondary exchange on which collectible tokens are traded (e.g., trade volume, floor prices, or current offers), or statistics from the issuing individual's social contribution and interaction with other users.

In accordance with a further aspect of the invention there is provided a system for creating and exchanging cryptographically verifiable utility tokens associated with an issuing individual, the system including a memory for storing computer-readable program code and a processor for executing the computer-readable program code, the system comprising:
an identity verifying component for verifying an identity of an issuing individual in respect of whom utility tokens are to be issued and an issuer account component for creating a token issuer account in respect of that issuing individual;
a token creating component for, subsequent to verification of the issuing individual's identity, causing a fixed number of utility tokens to be created, each utility token being associated with the issuing individual and being cryptographically verifiable;
a user registration component for receiving registration requests from a plurality of users and creating user accounts for each of the plurality of users,
during a first phase:
   an offer receiving component for receiving, from each of a first group of users, value offers to purchase an unspecified number of utility tokens;
   a face value generating component for generating a face value per utility token that optimizes a number of tokens and a total value of the tokens to be sold to the first group of users; and
   the face value generating component for enabling users to be added to the first group of users and enabling the first group of users to each increase their value offer such that the generated face value per utility token increases;
upon conclusion of the first phase, the face value generating component for generating a final face value per utility token and a payment transaction component for facilitating a payment transaction in which each user of the first group of users pays the final face value per utility token and receives a number of utility tokens based on that user's value offer, each purchased utility token being cryptographically linked to a user; and
subsequent to the first phase:
   a dynamic value generating component for determining a dynamic face value of the utility tokens;
   the dynamic value generating component for enabling the issuing individual and any user holding utility tokens to offer to sell utility tokens to a purchasing user at the dynamic face value;
   the payment transaction component for facilitating a payment transaction in which the purchasing user pays the dynamic face value and receives the offered utility tokens which are then cryptographically linked to the purchasing user.

The system may include, subsequent to verification of the issuing individual's identity,
the token creating component for causing a dynamic number of collectible tokens to be created, with each collectible token being associated with the issuing individual and being cryptographically verifiable;
a collectible token purchasing component for enabling the issuing individual to offer to sell collectible tokens to a purchasing user in the secondary exchange; and,
the payment transaction component for facilitating a payment transaction in which the purchasing user pays for the collectible tokens using utility tokens and/or fiat currency and receives the offered collectible tokens which are then cryptographically linked to the purchasing user.

In accordance with a further aspect of the invention there is provided a computer program product for creating and exchanging cryptographically verifiable utility tokens associated with an issuing individual, comprising a computer-readable medium having stored computer-readable program code for performing the steps of:
verifying an identity of an issuing individual in respect of whom utility tokens are to be issued and creating a token issuer account in respect of that issuing individual;
subsequent to verification of the issuing individual's identity, causing a fixed number of utility tokens to be created, each utility token being associated with the issuing individual and being cryptographically verifiable;
receiving registration requests from a plurality of users and creating user accounts for each of the plurality of users,
during a first phase:
   receiving, from each of a first group of users, value offers to purchase an unspecified number of utility tokens;
   generating a face value per utility token that optimizes a number of tokens and a total value of the tokens to be sold to the first group of users; and
   enabling users to be added to the first group of users and enabling the first group of users to each increase their value offer such that the generated face value per utility
upon conclusion of the first phase, generating a final face value per utility token and facilitating a payment transaction in which each user of the first group of users pays the final face value per utility token and receives a number of utility tokens based on that user's value offer, each purchased utility token being cryptographically linked to a user; and
subsequent to the first phase:
   determining a dynamic face value of the utility tokens;
   enabling the issuing individual and any user holding utility tokens to offer to sell utility tokens to a purchasing user at the dynamic face value;
   facilitating a payment transaction in which the purchasing user pays the dynamic face value and receives the offered utility tokens which are then cryptographically linked to the purchasing user.

Further features provide for the computer-readable medium to be a non-transitory computer-readable medium and for the computer-readable program code to be executable by a processing circuit.

Embodiments of the invention will now be described, by way of example only, with reference to the accompanying drawings.

### BRIEF DESCRIPTION OF THE DRAWINGS

In the drawings:

FIG. 1 is a schematic diagram which illustrates an exemplary system for creating and exchanging cryptographically verifiable utility tokens associated with an issuing individual according to aspects of the present disclosure;

FIG. 2A is a swim-lane flow diagram illustrating a method for verifying an identity of an issuing individual in respect of whom utility tokens are to be issued according to aspects of the present disclosure;

FIG. 2B is a swim-lane flow diagram illustrating a method for creating and exchanging cryptographically verifiable utility tokens associated with an issuing individual according to aspects of the present disclosure;

FIGS. 3A to 3L are illustrative screen shots showing exemplary interfaces that could be used in a method of registering a token issuer account according to aspects of the present disclosure;

FIG. 4 is a schematic diagram which illustrates a user interface of an exemplary utility token associated with an issuing individual;

FIG. 5 is a flow diagram of a method of determining a final face value of a utility token during a first phase;

FIGS. 6A to 6D are illustrative screen shots showing exemplary interfaces that could be used in the method of FIG. 5;

FIG. 7 is a schematic illustration of logical components of an exemplary server computer; and

FIG. 8 illustrates an example of a computing device in which various aspects of the disclosure may be implemented.

### DETAILED DESCRIPTION WITH REFERENCE TO THE DRAWINGS

A computer-implemented method and system is provided for creating and exchanging cryptographically verifiable utility tokens associated with an issuing individual. The utility tokens may be in the form of fungible cryptographic tokens which may be bought, sold, traded, transferred and/or stored by a purchasing user once created. A fixed number of utility tokens may be created and, during a first phase, value offers to purchase an unspecified number of utility tokens may be received from a first group of users. At the end of the first phase, a final face value per utility token may be determined that optimizes a number of tokens and a total value of the tokens to be sold to the first group of users. A payment transaction may be facilitated in which each user of the first group of users pays the final face value per utility token and receives a number of utility tokens based on that user's value offer. The purchased utility tokens may each be cryptographically linked to a user.

Subsequent to the first phase, a dynamic face value of the utility tokens may be determined. The issuing individual and any user holding utility tokens may be enabled to offer to sell utility tokens to a purchasing user at the dynamic face value. A payment transaction may be facilitated in which the purchasing user pays the dynamic face value and receives the offered utility tokens which may then be cryptographically linked to the purchasing user.

Subsequent to verification of the issuing individual's identity, a dynamic number of collectible tokens may be created, and the issuing individual may offer to sell the collectible tokens to a purchasing user in a secondary exchange. A payment transaction may then be facilitated in which the purchasing user pays for the collectible tokens using utility tokens and/or fiat currency. The offered collectible tokens may then be cryptographically linked to the purchasing user.

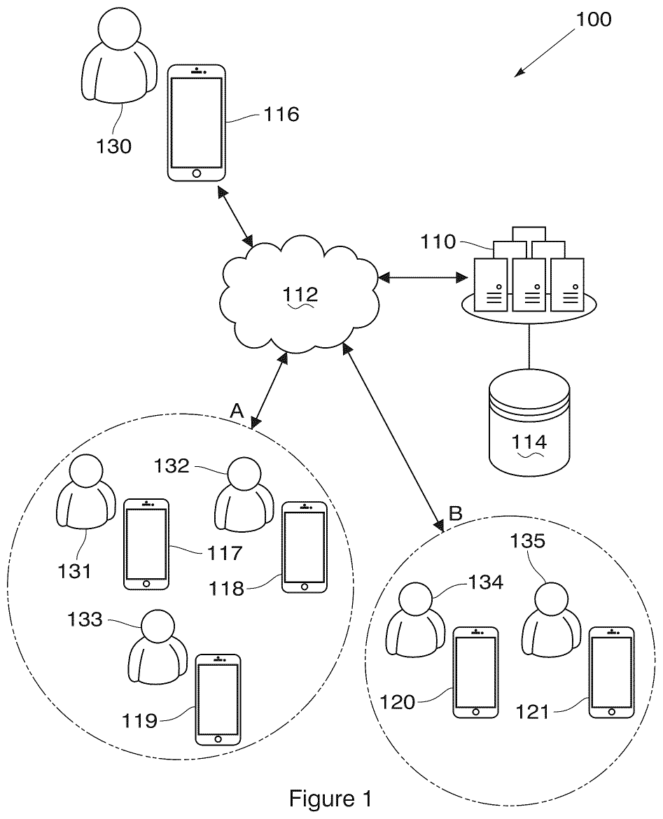

FIG. 1 is a schematic diagram which illustrates an exemplary system (100) for creating and exchanging cryptographically verifiable utility tokens associated with an issuing individual according to aspects of the present disclosure.

The system (100) includes a server computer (110) in communication with a plurality of electronic devices (116 to 121) over a communication network (112). A database (114) is associated with the server computer (110). In the present embodiment, a plurality of electronic devices (116 to 121) are shown, each electronic device belonging to an associated user (130 to 135). Although only few electronic devices are shown, it is of course understood that a large number of devices will be included in the system. In a preferred embodiment, a mobile application operating on the electronic devices will facilitate operation of the system, although the system may be operated through other means on the electronic devices such as a webpage accessible by a web browser.

Any suitable electronic device may be used, including, but not limited to, a mobile smartphone, a tablet computer, a desktop, laptop, smart watch, wearable computer or the like. Communication between the server computer and each electronic device may take place over any suitable communication network (112), including a local wireless network, third generation (3G), fourth generation (4G) or fifth generation (5G) cellular network, high-speed downlink packet access (HSDPA) network, and general packet radio service (GPRS) network to name but a few examples. In a preferred embodiment, each electronic device is capable of directly communicating with the server computer through the communication channel, however, it is envisaged that this may not always be possible and in such cases an electronic device may be enabled to communicate with the server computer utilizing the communication capabilities of another communication device, for example a smart watch that uses the communication capabilities of a smartphone.

The technology described in this application provides computer-implemented methods and systems for creating and exchanging cryptographically verifiable utility tokens associated with an issuing individual. The issuing individual may be someone who a purchaser of a utility token wants to obtain a benefit, for example, talented persons, athletes, celebrities, musicians, actors, businesspersons, politicians or the like. An issuing individual (130) using his/her electronic device (116) may wish to create utility tokens to be exchanged. The server computer (110) may verify the identity of the issuing individual (130) and may create a token issuer account of the issuing individual (130). A fixed number of utility tokens may be created with each being associated with the issuing individual (130) and being cryptographically verifiable.

The server computer (110) may receive registration requests from electronic devices (117 to 121) of a plurality of users (131 to 135) and may respectively create user accounts for each of the plurality of users. During a first phase, the server computer (110) may receive from each of a first group of users (Circle A), value offers to purchase an unspecified number of utility tokens and may generate a face value per utility token that optimizes a number of tokens and a total value of the tokens to be sold to the first group of users (Circle A). The server computer (110) may enable users to be added to the first group of users and may enable the first group of users to each increase their value offer such that the generated face value per utility token increases. Upon conclusion of the first phase, the server computer (110) may generate a final face value per utility token and may facilitate a payment transaction in which each user of the first group of users (Circle A) pays the final face value per utility token and receives a number of utility tokens based on that user's value offer. Each purchased utility token may then be cryptographically linked to a user (131 to 133).

Subsequent to the first phase, the server computer (110) may determine a dynamic face value of the utility tokens and may enable the issuing individual and any user (131 to 133) holding utility tokens to offer to sell utility tokens to a purchasing user (134, 135) at the dynamic face value. The server computer (110) may then facilitate a payment transaction in which the purchasing user (134, 135) pays the dynamic face value and receives the offered utility tokens which may then be cryptographically linked to the purchasing user (134, 135). In some embodiments, any user (131 to 133) holding utility tokens may offer to sell utility tokens to a purchasing user (134, 135) at a value of their choosing. The server computer (110) may then facilitate a payment transaction in which the purchasing user (134, 135) pays that value and receives the offered utility tokens which may then be cryptographically linked to the purchasing user (134, 135).

Subsequent to verification of the issuing individual's identity, the server computer (110) may cause a dynamic number of collectible tokens to be created, with each collectible token being associated with the issuing individual and being cryptographically verifiable. The server computer (110) may enable the issuing individual (130) to offer to sell collectible tokens to a purchasing user (131 to 135) in a secondary exchange and may facilitate a payment transaction in which the purchasing user (131 to 135) pays for the collectible tokens using utility tokens and/or fiat currency. The purchasing user (131 to 135) then receives the offered collectible tokens which are then cryptographically linked to the purchasing user (131 to 135). It is appreciated that the server computer (110) may enable purchasing users (131 to 135) to subsequently offer to sell and/or purchase collectible tokens amongst each other using utility tokens and/or fiat currency.

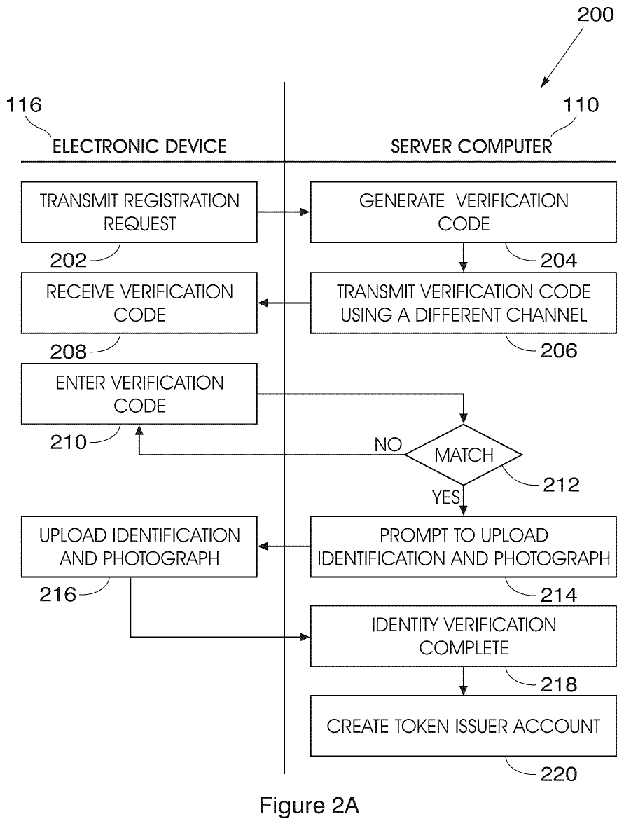

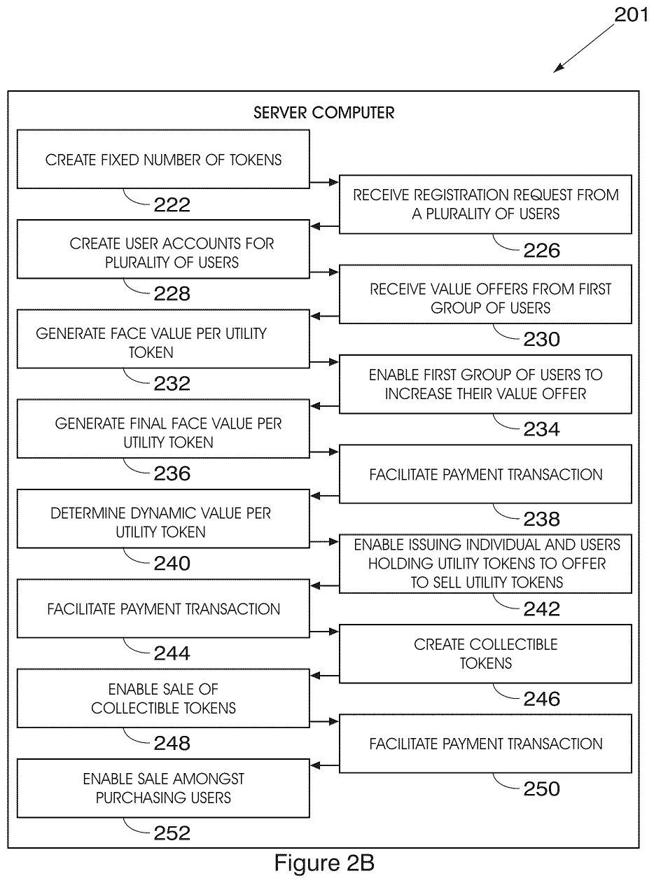

FIG. 2A illustrates a swim-lane flow diagram of an exemplary method (200) for verifying an identity of an issuing individual in respect of whom utility tokens are to be issued in which respective swim-lanes delineate steps, operations or procedures performed by respective entities or devices.

An issuing individual (130) may install and launch a mobile application on his/her electronic device (116), in this embodiment, the individual's smartphone. The mobile application operating on the electronic device (116) may facilitate operation of the method (200), although the method (200) may be operated through other means on the electronic device (116) such as a webpage accessible by a web browser.

The electronic device (116) may transmit (202) a registration request to the server computer (110). The server computer (110) may receive the request, may generate (204) a verification code and may transmit (206) the verification code to the electronic device (116) using a different channel, typically through a channel such as Electronic Mail (email) or Short Message Service (SMS). Transmitting the verification code through a different channel than the mobile application ensures that only the individual in control of that other channel will receive the verification code. If email is used as the channel, only an individual in possession of the email address should receive the email. If SMS is used as the channel, only a user in possession of the mobile device subscriber identify module (SIM) associated with the SMS should receive the SMS. Therefore, using SMS as a verification channel provides a high degree of certainty that a user is providing their true mobile phone number. It will be appreciated that the server computer may interface with a third bulk messaging service for the generation and transmission of such verification codes.

The electronic device (116) may receive (208) the verification code through the different channel and the issuing individual (130) may enter (210) the verification code. The server computer (110) may receive the verification code and may compare (212) it with the transmitted code. If the codes do not match, the issuing individual (130) may be prompted to enter (210) the verification code again. If the codes do match, the server computer (110) may prompt (214) the issuing individual to upload his/her identification document such as a national identity card or a passport for further verification as well as a photograph to be used as a profile picture. The issuing individual (130) may upload (216) his/her identification document and the server computer (110) may complete (118) the verification of the issuing individual's (130) identity. This may further ensure that the issuing individual (130) is indeed the person whom he/she claims to be. Once the identity verification is complete (218), the server computer (110) may create (220) a token issuer account in respect of that issuing individual (130).

The newly created token issuer account may be stored in the database (114) and the issuing individual (130) may simply login to the account. In one embodiment, a two-factor authentication may be required to login to the token issuer account and similar verification steps may be used.

FIG. 2B illustrates a swim-lane flow diagram of an exemplary method (201) for creating and exchanging cryptographically verifiable utility tokens associated with an issuing individual in which respective swim-lanes delineate steps, operations or procedures performed by respective entities or devices.

After the issuing individual's (130) identity is verified and the token issuer account created, the server computer (110) may cause a fixed number of utility tokens to be created (222), with each utility token being associated with the issuing individual (130) and being cryptographically verifiable. The fixed number of utility tokens may be several thousand in the form of fungible cryptographic tokens which may be bought, sold, traded, transferred and or stored by a purchaser once created. In one embodiment, fixed number of utility tokens may be 100,000.

The server computer (110) may receive (226) registration requests from a plurality of users and may create (228) user accounts for each of the plurality of users. In some embodiments, the user accounts may be created using a similar method as describe above in respect of the token issuer account and similar verification steps may also be used.

During a first phase, the server computer (110) may receive (230) from each of a first group of users, value offers to purchase an unspecified number of utility tokens, and may generate (232) a face value per utility token that optimizes a number of tokens and a total value of the tokens to be sold to the first group of users. The server computer (110) may enable users to be added to the first group of users and may enable (234) the first group of users to each increase their value offer such that the generated face value per utility token increases. Upon conclusion of the first phase, the server computer (110) may generate (236) a final face value per utility token and may facilitate (238) a payment transaction in which each user of the first group of users pays the final face value per utility token and receives a number of utility tokens based on that user's value offer. Each purchased utility token may then be cryptographically linked to a user.

The first phase may be divided into a number of stages, with the face value per utility token being updated at the end of each stage. The first phase may be 7 days, divided into 7 equal stages of 1 day. At the end of each day all value offers may be tallied and a face value, which may be the weighted average price, may be generated. On the next day, new value offers may only be received if the new value offer is higher than the face value generated at the end of the previous day, to enable a higher face value per utility token to be generated at the end of the current day. The final face value per utility token may be the weighted average price generated at the end of the 7th day. This may enable the issuing individual (130) a window of opportunity to obtain and establish a best face value of the utility token.

The weighted average price may optimize the number of tokens issued and the total value of the tokens sold to the first group of users. For example, in a first scenario, the first group of users may be 100 users making offers of $1 for each utility token. If the weighted average price generated is $1, then each user may be issued with 10 utility tokens, thus making a total value of the utility tokens sold to be $1,000. In a second scenario, we may have one user making an offer of $1,000 for each utility token. If the weighted average price generated is $1, then the user may be issued with 1,000 utility tokens, thus making a total value of the utility tokens sold to be $1,000. In both scenarios, 1,000 utility tokens will be issued, and the total value of the utility tokens sold is $1,000.

Subsequent to the first phase, the server computer (110) may determine (240) a dynamic face value of the utility tokens, may enable (242) the issuing individual and any user holding utility tokens to offer to sell utility tokens in a secondary exchange, and may facilitate (244) a payment transaction in which the purchasing user pays the dynamic face value and receives the offered utility tokens which may then be cryptographically linked to the purchasing user.

The secondary exchange may be a peer-to-peer market where users can freely trade utility tokens at any price of their choosing. In the secondary exchange, the issuing individual may only list utility tokens for sale at the dynamic face value of the utility tokens. The dynamic face value of the utility tokens may initially be the final face value determined at the end of the first phase and may be continuously redetermined based on the higher of the last executed trade price or the lowest ask in the secondary exchange. For example, if a user buys a utility token at $5, and there is a utility token for sale at $4.50, then the dynamic face value of the utility token will be $5, which is the highest price that the utility token was bought at. However, if there is a utility token for sale at $6, then the dynamic face value of the utility token will be $6, which is the lowest price which the utility token is for sale regardless of whether that utility token is sold or not.

Subsequent to verification of the issuing individual's identity, the server computer (110) may cause a dynamic number of collectible tokens to be created (246), with each collectible token being associated with the issuing individual and being cryptographically verifiable. The server computer (110) may enable (248) the issuing individual to offer to sell collectible tokens to a purchasing user in a secondary exchange and may facilitate (250) a payment transaction in which the purchasing user pays for the collectible tokens using utility tokens and/or fiat currency. The purchasing user then receives the offered collectible tokens which are cryptographically linked to the purchasing user. The server computer (110) may further enable (252) purchasing users to subsequently offer to sell and/or purchase collectible tokens amongst each other using utility tokens and/or fiat currency.

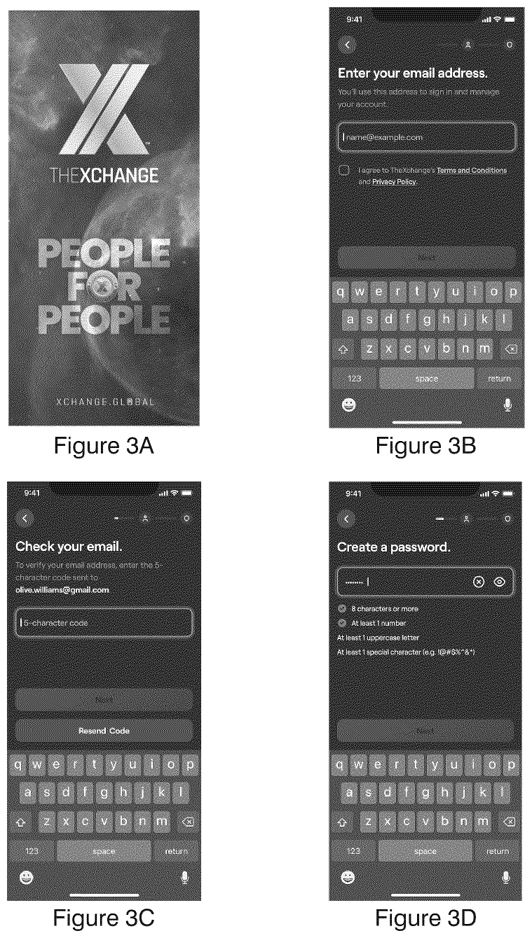

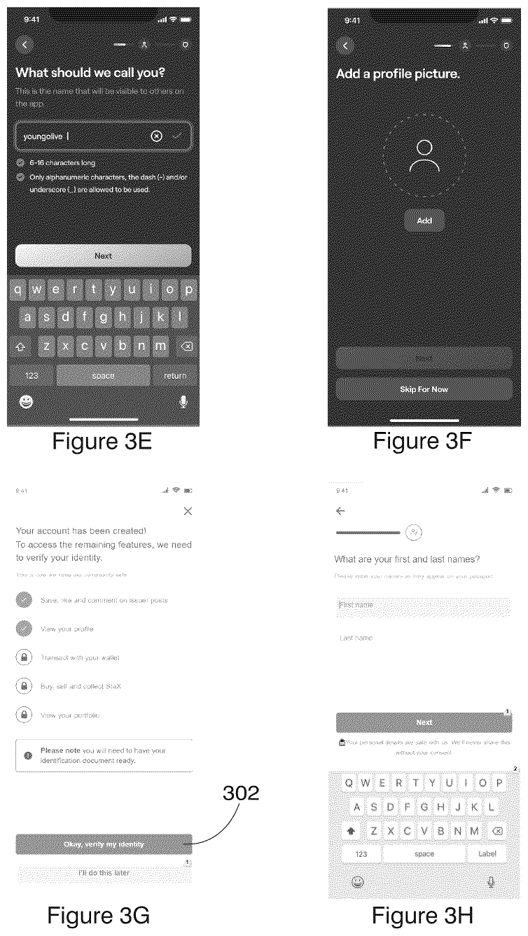

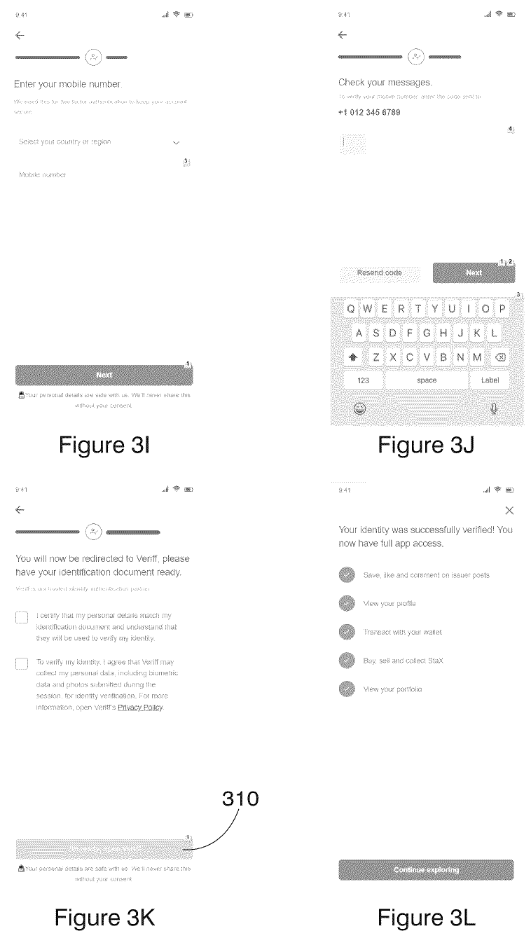

FIGS. 3A to 3L are illustrative screen shots showing exemplary interfaces that could be used in a method of registering a token issuer account according to aspects of the present disclosure. The issuing individual (130) may install and launch a mobile application on his/her electronic device (116) and may be presented with a splash page (FIG. 3A). The individual may be prompted to register by providing his/her email (FIG. 3B) and inputting a verification code (FIG. 3C) received from the server computer (110) through a different channel, typically through a channel such as Electronic Mail (email). Once the verification code has been provided, the issuing individual is prompted to create a password (FIG. 3D), provide a username (FIG. 3E) and provide a profile picture (FIG. 3F). The server computer (110) may enable the issuing individual to provide the profile picture at a later time. Once these have been provided, the token issuer account in respect of that issuing individual may be created (FIG. 3G) however, the issuing individual will have limited access. The issuing individual (130) may then be prompted to verify (302) his/her identity and is prompted to provide a first and last name (FIG. 3H) and to enter a mobile number (FIG. 3I) where a verification code will be transmitted through a different channel, typically through a channel such as a Short Message Service (SMS). The issuing individual (130) may then input the verification code (FIG. 3J) and may be prompted (310, FIG. 3K) to upload identification such as a national identity card or a passport for further verification. The uploaded identification may be associated with the token issuer account. This may further ensure that the issuing individual (130) is indeed that whom he/she claims to be. Once verified, the issuing individual (130) may have full access to the mobile application (FIG. 3L).

User accounts of a plurality of users may be created using a similar method as described above. It is appreciated that the token issuer account may be operable on a mobile application operating on the electronic device (116) of the issuing individual (130) and the user accounts may be operable on a different mobile application operating on the electronic device (117 to 121) of the plurality of users (131 to 135).

After verification of the issuing individual's identity, a fixed number of utility tokens may be created, with each utility token being associated with the issuing individual and being cryptographically verifiable. The utility tokens may be recorded to a distributed ledger technology in the form of fungible tokens such as an ERC-21 smart contract. The token ownership may then be updated on the ledger whenever the token changes between users.

After verification of the issuing individual's identity, a dynamic number of collectible tokens may be created, with each collectible token being associated with the issuing individual and being cryptographically verifiable. The collectible tokens may be recorded to a distributed ledger technology in the form of non-fungible tokens such as an ERC-721 smart contract. The token ownership may then be updated on the ledger whenever a specific token changes between users.

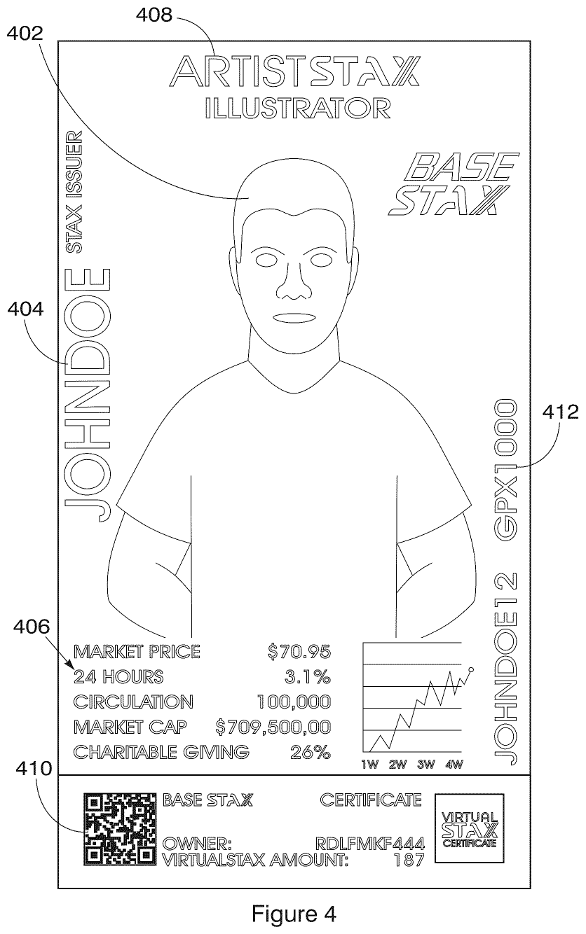

FIG. 4 is a schematic diagram which illustrates a user interface of an exemplary utility token associated with an issuing individual. The utility token may include embedded data associated with the individual including a foreground image (402) and a display name (404) of the issuing individual, statistics (406) related specifically to the market on which utility tokens associated with the issuing individual may be exchanged, and an exchange background image (408) if it is being traded in a secondary exchange. The utility token may include a sponsor image of a sponsor of the issuing individual, a token certificate including a pattern or a quick response (QR) code (410) and a global performance index (GPX) value (412) of the issuing individual. The QR code may contain a URL link to a website under secondary exchange ownership. This URL may display the token certificate, including the ownership, and a link to a chain explorer where the token and its ownership information is available.

A collectible token may comprise a customizable background image, a foreground image of the issuing individual, the name and surname of the issuing individual, customizable statistics or attributes, a QR code which may contain a link to a blockchain explorer to verify ownership of a specific token and/or the global performance index (GPX) of issuing individual.

In one embodiment, an issuing individual may be issued with 100,000 utility tokens (or “BaseStaX”). The issuing individual may have registered in any of the following categories: sports (athletes & teams); Esports; actors; artists; businesspersons; politicians; or celebrities. In this embodiment, the issuing individual may have registered as an athlete. The athlete may sell the BaseStaX during a first phase (an “Initial StaX Offering” (ISO)). All 100,000 BaseStaX may be sold during the Initial StaX Offering (ISO). The ISO may be a live auction over a 7-day period and a face value per BaseStaX may be generated at the end of each day. Upon conclusion of the ISO, a final face value of the BaseStaX may be generated which optimizes the number of BaseStaX issued and a total value of the BaseStaX sold to the buyers in first group of users.

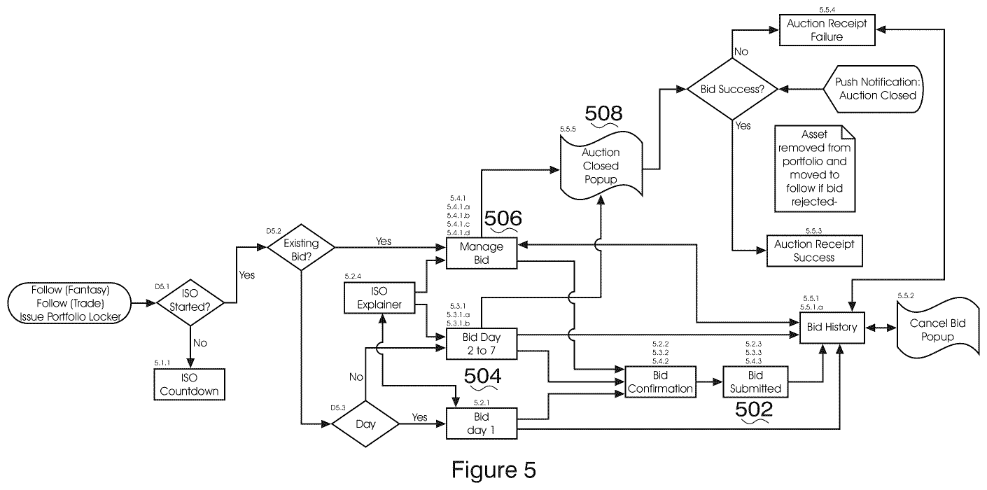

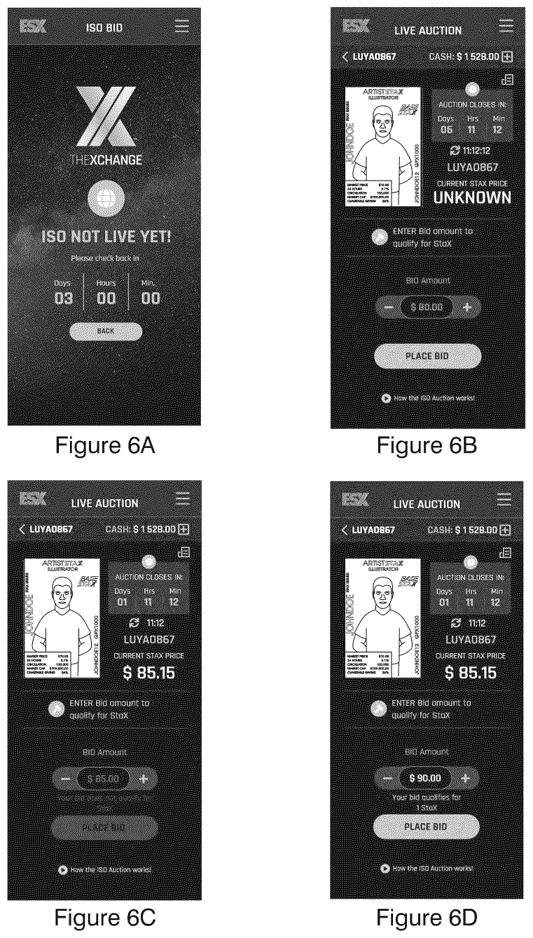

FIG. 5 is a flow diagram of a method of determining a final face value of a utility token during a first phase and FIGS. 6A to 6D are illustrative screen shots showing exemplary interfaces that could be used in the method. A countdown (FIG. 6A) may be set in which the ISO may “go live”, and on Day 1 of the Live Auction (first 24 hour period), a potential buyer in the first group of users (bidders) may place a bid (502, FIG. 6B) indicating how much they would be willing to pay for one or more BaseStaX, in this embodiment, the user places a bid of $80. At the end of the day all bids are tallied and a face value for the athlete's BaseStaX over the previous 24-hour period is generated. In this embodiment a face value is the weighted average price which is $85.15 (FIG. 6C).

On Day 2 of the live auction (second 24 hour period), existing users of the first group of users or new users (bidders) may see (504) the weighted bid average price. This may determine the number of BaseStaX they qualify for at that stage of the auction. The existing bidders may then be allowed to increase (506, FIG. 6D) their total bid amount or cancel their bid if it is too low, and new bidders may only place bids that are higher than the weighted bid average price of the previous day. Bids may only be cancelled at this time but may be increased at any point within the 24 hour window. New users or buyers may now place a bid indicating the amount they would be willing to pay for one or more BaseStaX, using the previous day's weighted bid average price as a pricing guideline.

At the end of every 24 hour period the weighted bid average price will be updated and once again bidders may then decide to increase their bid or cancel their bid if too low. A bid may not be cancelled unless it falls below the weighted bid average price. At the end of the 7-day live auction (608), the athlete's weighted bid average price will be the final face value for the athlete's BaseStaX. The ISOmay enable the athlete a window of opportunity to obtain and establish a best face value of the BaseStaX. The final face value for the athlete's BaseStaX may then be the starting price per BaseStaX in the secondary exchange. It may be possible that at the end of the 7-day live auction period not all BaseStaX are sold, these may then be sold on the secondary exchange.

The secondary exchange may be a peer-to-peer market where users can freely trade BaseStaXs at any price of their choosing. The dynamic face value may initially be the final face value determined at the end of the ISO and may be continuously redetermined based on the higher of the last executed trade price or the lowest asking price in the secondary exchange. For example, if a user buys a BaseStaX at $5, and there is a BaseStaX for sale at $4.50, then the dynamic face value of the BaseStaX will be $5, which is the highest price at which the BaseStaX was bought. However, if there is a BaseStaX for sale at $6, then the dynamic face value of the BaseStaX will be $6, which is the lowest price that the BaseStaX is for sale at regardless of whether that BaseStaX is sold or not.

A Global Performance Index (GPX) for each BaseStaX may be determined where the GPX may be a measure of the athlete's performance within the platform (i.e., the VirtualStax platform). The GPX may be calculated based on: statistics from the secondary exchange on which utility tokens are traded (e.g., the current price, trading volume, volume weighted average prices, or number of holders of utility tokens), statistics from the secondary exchange on which collectible tokens are traded (e.g., trade volume, floor prices, or current offers), or statistics from the issuing individual's social contribution and interaction with other users.

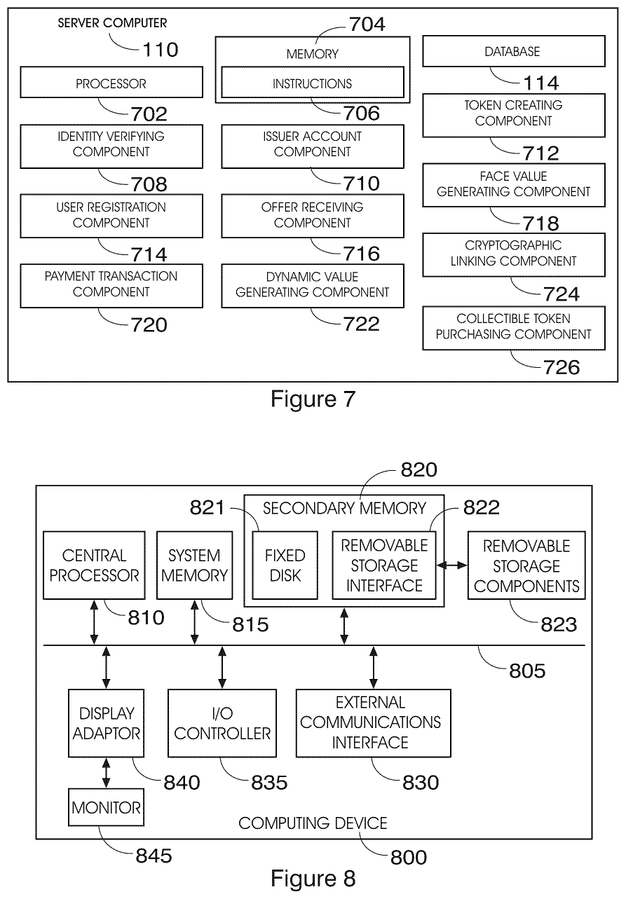

Logical components of an exemplary server computer (110) are shown in FIG. 7. A database (114) is associated with the server computer (110). The server computer (110) may include a processor (702) for executing the functions of components described below, which may be provided by hardware or by software units executing on the server computer (110). The software units may be stored in a memory component (704) and instructions (706) may be provided to the processor (702) to carry out the functionality of the described components. In some cases, for example in a cloud computing implementation, software units arranged to manage and/or process data on behalf of the server computer (110) may be provided remotely.

The server computer (110) may include an identity verifying component (708), an issuer account component (710), a token creating component (712), a user registration component (714), an offer receiving component (716), a face value generating component (718), a payment transaction component (720), a dynamic value component (722), a cryptographic linking component (724), and a collectible token purchasing component (726).

The identity verifying component (708) may be arranged to verify an identity of an issuing individual in respect of whom utility tokens are to be issued. The issuer account component (710) may be arranged to create a token issuer account in respect of that issuing individual. The token creating component (712) may be arranged to cause a fixed number of utility tokens and/or a dynamic number of collectible tokens to be created subsequent to verification of the issuing individual's identity, with each utility token or collectible tokens being associated with the issuing individual and being cryptographically verifiable and the user registration component (714) may be arranged to receive registration requests from a plurality of users and creating user accounts for each of the plurality of users.

During a first phase, the offer receiving component (716) may be arranged to receive, from each of a first group of users, value offers to purchase an unspecified number of utility tokens. The face value generating component (718) may to arranged to generate a face value per utility token that optimizes a number of tokens and a total value of the tokens to be sold to the first group of users, enable users to be added to the first group of users and enable the first group of users to each increase their value offer such that the generated face value per utility token increases.

Upon conclusion of the first phase, the face value generating component (718) may be arranged to generate a final face value per utility token and a payment transaction component (720) may be arranged to facilitate a payment transaction in which each user of the first group of users pays the final face value per utility token and receives a number of utility tokens based on that user's value offer. The cryptographic linking component (724) may be arranged to cryptographically link the purchased utility token to a user.

Subsequent to the first phase, the dynamic value generating component (722) may be arranged to determine a dynamic face value of the utility tokens and enable the issuing individual and any user holding utility tokens to offer to sell utility tokens to a purchasing user at the dynamic face value. The payment transaction component (720) may be arranged to facilitate a payment transaction in which the purchasing user pays the dynamic face value and the cryptographic linking component (724) may be arranged to cryptographically link the purchased utility token to the purchasing user.

Subsequent to verification of the issuing individual's identity, the collectible token purchasing component (726) may be arranged to enable the issuing individual to offer to sell collectible tokens to a purchasing user in the secondary exchange and the payment transaction component (720) may be arranged to facilitate a payment transaction in which the purchasing user pays for the collectible tokens using utility tokens and/or fiat currency.

FIG. 8 illustrates an example of a computing device (800) in which various aspects of the disclosure may be implemented. The computing device (800) may be embodied as any form of data processing device including a personal computing device (e.g., laptop or desktop computer), a server computer (which may be self-contained, physically distributed over a number of locations), a client computer, or a communication device, such as a mobile phone (e.g., cellular telephone), satellite phone, tablet computer, personal digital assistant or the like. Different embodiments of the computing device may dictate the inclusion or exclusion of various components or subsystems described below.

The computing device (800) may be suitable for storing and executing computer program code. The various participants and elements in the previously described system diagrams may use any suitable number of subsystems or components of the computing device (800) to facilitate the functions described herein. The computing device (800) may include subsystems or components interconnected via a communication infrastructure (805) (for example, a communications bus, a network, etc.). The computing device (800) may include one or more processors (810) and at least one memory component in the form of computer-readable media. The one or more processors (810) may include one or more of: CPUs, graphical processing units (GPUs), microprocessors, field programmable gate arrays (FPGAs), application specific integrated circuits (ASICs) and the like. In some configurations, a number of processors may be provided and may be arranged to carry out calculations simultaneously. In some implementations various subsystems or components of the computing device (800) may be distributed over a number of physical locations (e.g., in a distributed, cluster or cloud-based computing configuration) and appropriate software units may be arranged to manage and/or process data on behalf of remote devices.

The memory components may include system memory (815), which may include read only memory (ROM) and random access memory (RAM). A basic input/output system (BIOS) may be stored in ROM. System software may be stored in the system memory (815) including operating system software. The memory components may also include secondary memory (820). The secondary memory (820) may include a fixed disk (821), such as a hard disk drive, and, optionally, one or more storage interfaces (822) for interfacing with storage components (823), such as removable storage components (e.g., magnetic tape, optical disk, flash memory drive, external hard drive, removable memory chip, etc.), network attached storage components (e.g. NAS drives), remote storage components (e.g. cloud-based storage) or the like.

The computing device (800) may include an external communications interface (830) for operation of the computing device (800) in a networked environment enabling transfer of data between multiple computing devices (800) and/or the Internet. Data transferred via the external communications interface (830) may be in the form of signals, which may be electronic, electromagnetic, optical, radio, or other types of signal. The external communications interface (830) may enable communication of data between the computing device (800) and other computing devices including servers and external storage facilities. Web services may be accessible by and/or from the computing device (800) via the communications interface (830).

The external communications interface (830) may be configured for connection to wireless communication channels (e.g., a cellular telephone network, wireless local area network (e.g. using Wi-Fi™), satellite-phone network, Satellite Internet Network, etc.) and may include an associated wireless transfer element, such as an antenna and associated circuitry. The external communications interface (830) may include a subscriber identity module (SIM) in the form of an integrated circuit that stores an international mobile subscriber identity and the related key used to identify and authenticate a subscriber using the computing device (800). One or more subscriber identity modules may be removable from or embedded in the computing device (800).

The computer-readable media in the form of the various memory components may provide storage of computer-executable instructions, data structures, program modules, software units and other data. A computer program product may be provided by a computer-readable medium having stored computer-readable program code executable by the central processor (810). A computer program product may be provided by a non-transient or non-transitory computer-readable medium, or may be provided via a signal or other transient or transitory means via the communications interface (830).

Interconnection via the communication infrastructure (805) allows the one or more processors (810) to communicate with each subsystem or component and to control the execution of instructions from the memory components, as well as the exchange of information between subsystems or components. Peripherals (such as printers, scanners, cameras, or the like) and input/output (I/O) devices (such as a mouse, touchpad, keyboard, microphone, touch-sensitive display, input buttons, speakers and the like) may couple to or be integrally formed with the computing device (800) either directly or via an I/O controller (835). One or more displays (845) (which may be touch-sensitive displays) may be coupled to or integrally formed with the computing device (800) via a display or video adapter (840).

The foregoing description has been presented for the purpose of illustration; it is not intended to be exhaustive or to limit the invention to the precise forms disclosed. Persons skilled in the relevant art can appreciate that many modifications and variations are possible in light of the above disclosure.

Any of the steps, operations, components or processes described herein may be performed or implemented with one or more hardware or software units, alone or in combination with other devices. Components or devices configured or arranged to perform described functions or operations may be so arranged or configured through computer-implemented instructions which implement or carry out the described functions, algorithms, or methods. The computer-implemented instructions may be provided by hardware or software units. In one embodiment, a software unit is implemented with a computer program product comprising a non-transient or non-transitory computer-readable medium containing computer program code, which can be executed by a processor for performing any or all of the steps, operations, or processes described. Software units or functions described in this application may be implemented as computer program code using any suitable computer language such as, for example, Java™, C++, or Perl™ using, for example, conventional or object-oriented techniques. The computer program code may be stored as a series of instructions, or commands on a non-transitory computer-readable medium, such as a random access memory (RAM), a read-only memory (ROM), a magnetic medium such as a hard-drive, or an optical medium such as a CD-ROM. Any such computer-readable medium may also reside on or within a single computational apparatus, and may be present on or within different computational apparatuses within a system or network.

Flowchart illustrations and block diagrams of methods, systems, and computer program products according to embodiments are used herein. Each block of the flowchart illustrations and/or block diagrams, and combinations of blocks in the flowchart illustrations and/or block diagrams, may provide functions which may be implemented by computer readable program instructions. In some alternative implementations, the functions identified by the blocks may take place in a different order to that shown in the flowchart illustrations.

Some portions of this description describe the embodiments of the invention in terms of algorithms and symbolic representations of operations on information. These algorithmic descriptions and representations, such as accompanying flow diagrams, are commonly used by those skilled in the data processing arts to convey the substance of their work effectively to others skilled in the art. These operations, while described functionally, computationally, or logically, are understood to be implemented by computer programs or equivalent electrical circuits, microcode, or the like. The described operations may be embodied in software, firmware, hardware, or any combinations thereof.

The language used in the specification has been principally selected for readability and instructional purposes, and it may not have been selected to delineate or circumscribe the inventive subject matter. It is therefore intended that the scope of the invention be limited not by this detailed description, but rather by any claims that issue on an application based hereon. Accordingly, the disclosure of the embodiments of the invention is intended to be illustrative, but not limiting, of the scope of the invention set forth in any accompanying claims.

Finally, throughout the specification and any accompanying claims, unless the context requires otherwise, the word ‘comprise’ or variations such as ‘comprises’ or ‘comprising’ will be understood to imply the inclusion of a stated integer or group of integers but not the exclusion of any other integer or group of integers.

1. A computer-implemented method for creating and exchanging cryptographically verifiable utility tokens associated with an issuing individual, comprising:
verifying an identity of an issuing individual in respect of whom utility tokens are to be issued and creating a token issuer account in respect of that issuing individual;
subsequent to verification of the issuing individual's identity, causing a fixed number of utility tokens to be created, each utility token being associated with the issuing individual and being cryptographically verifiable;
receiving registration requests from a plurality of users and creating user accounts for each of the plurality of users,
during a first phase:
receiving, from each of a first group of users, value offers to purchase an unspecified number of utility tokens;
generating a face value per utility token that optimizes a number of tokens and a total value of the tokens to be sold to the first group of users; and
enabling users to be added to the first group of users and enabling the first group of users to each increase their value offer such that the generated face value per utility token increases;
upon conclusion of the first phase, generating a final face value per utility token and facilitating a payment transaction in which each user of the first group of users pays the final face value per utility token and receives a number of utility tokens based on that user's value offer, each purchased utility token being cryptographically linked to a user; and
subsequent to the first phase:
determining a dynamic face value of the utility tokens;
enabling the issuing individual and any user holding utility tokens to offer to sell utility tokens to a purchasing user at the dynamic face value;
facilitating a payment transaction in which the purchasing user pays the dynamic face value and receives the offered utility tokens which are then cryptographically linked to the purchasing user.

2. The method as claimed in claim 1, wherein first phase is divided into a number of stages, with the face value per utility token being the weighted average value offer and being updated at the end of each stage.

3. The method as claimed in claim 1, including, subsequent to the first phase, the issuing individual and any user holding utility tokens offering to sell utility tokens in a secondary exchange.

4. The method as claimed in claim 3, wherein the issuing individual can only sell utility tokens at the dynamic face value in the secondary exchange, the dynamic face value being initially the final face value determined at the end of the first phase and being continuously redetermined based on the higher of the last executed trade price or the lowest asking price in the secondary exchange.

5. The method as claimed claim 1, including, subsequent to verification of the issuing individual's identity, causing a dynamic number of collectible tokens to be created, with each collectible token being associated with the issuing individual and being cryptographically verifiable;
enabling the issuing individual to offer to sell collectible tokens to a purchasing user in a secondary exchange; and,
facilitating a payment transaction in which the purchasing user pays for the collectible tokens using utility tokens and/or fiat currency and receives the offered collectible tokens which are then cryptographically linked to the purchasing user.

6. The method as claimed in claim 5, wherein the collectible tokens include embedded data associated with the individual, the embedded data including an image or video of the individual, and a name of the individual.

7. The method as claimed claim 1, including determining a global performance index of the issuing individual, wherein the global performance index is a dynamic value determined by combining metrics obtained from the sale of utility tokens in a secondary exchange and metrics related to the social interaction between users and the issuing individual.

8. The method as claimed in claim 7, wherein the global performance index is calculated based on statistics from the secondary exchange on which utility tokens are traded, statistics from the secondary exchange on which collectible tokens are traded, or statistics from the issuing individual's social contribution and interaction with other users.

9. A system for creating and exchanging cryptographically verifiable utility tokens associated with an issuing individual, the system including a memory for storing computer-readable program code and a processor for executing the computer-readable program code, the system comprising:
an identity verifying component for verifying an identity of an issuing individual in respect of whom utility tokens are to be issued and an issuer account component for creating a token issuer account in respect of that issuing individual;
a token creating component for, subsequent to verification of the issuing individual's identity, causing a fixed number of utility tokens to be created, each utility token being associated with the issuing individual and being cryptographically verifiable;
a user registration component for receiving registration requests from a plurality of users and creating user accounts for each of the plurality of users, during a first phase:
an offer receiving component for receiving, from each of a first group of users, value offers to purchase an unspecified number of utility tokens;
a face value generating component for generating a face value per utility token that optimizes a number of tokens and a total value of the tokens to be sold to the first group of users; and
the face value generating component for enabling users to be added to the first group of users and enabling the first group of users to each increase their value offer such that the generated face value per utility token increases;
upon conclusion of the first phase, the face value generating component for generating a final face value per utility token and a payment transaction component for facilitating a payment transaction in which each user of the first group of users pays the final face value per utility token and receives a number of utility tokens based on that user's value offer, each purchased utility token being cryptographically linked to a user; and
subsequent to the first phase:
a dynamic value generating component for determining a dynamic face value of the utility tokens;
the dynamic value generating component for enabling the issuing individual and any user holding utility tokens to offer to sell utility tokens to a purchasing user at the dynamic face value;
the payment transaction component for facilitating a payment transaction in which the purchasing user pays the dynamic face value and receives the offered utility tokens which are then cryptographically linked to the purchasing user.

10. The system as claimed in claim 9, including, subsequent to verification of the issuing individual's identity,
the token creating component for causing a dynamic number of collectible tokens to be created, with each collectible token being associated with the issuing individual and being cryptographically verifiable;
a collectible token purchasing component for enabling the issuing individual to offer to sell collectible tokens to a purchasing user in the secondary exchange; and,
the payment transaction component for facilitating a payment transaction in which the purchasing user pays for the collectible tokens using utility tokens and/or fiat currency and receives the offered collectible tokens which are then cryptographically linked to the purchasing user.

11. A computer program product for creating and exchanging cryptographically verifiable utility tokens associated with an issuing individual, comprising a computer-readable medium having stored computer-readable program code for performing the steps of:
verifying an identity of an issuing individual in respect of whom utility tokens are to be issued and creating a token issuer account in respect of that issuing individual;
subsequent to verification of the issuing individual's identity, causing a fixed number of utility tokens to be created, each utility token being associated with the issuing individual and being cryptographically verifiable;
receiving registration requests from a plurality of users and creating user accounts for each of the plurality of users,
during a first phase:
receiving, from each of a first group of users, value offers to purchase an unspecified number of utility tokens;
generating a face value per utility token that optimizes a number of tokens and a total value of the tokens to be sold to the first group of users; and
enabling users to be added to the first group of users and enabling the first group of users to each increase their value offer such that the generated face value per utility token increases;
upon conclusion of the first phase, generating a final face value per utility token and facilitating a payment transaction in which each user of the first group of users pays the final face value per utility token and receives a number of utility tokens based on that user's value offer, each purchased utility token being cryptographically linked to a user; and
subsequent to the first phase:
determining a dynamic face value of the utility tokens;
enabling the issuing individual and any user holding utility tokens to offer to sell utility tokens to a purchasing user at the dynamic face value;
facilitating a payment transaction in which the purchasing user pays the dynamic face value and receives the offered utility tokens which are then cryptographically linked to the purchasing user.
